(19) United States
(12) Patent Application Publication
(10) Pub. No.: US 2007/0294332 A1
(43) Pub. Date: Dec. 20, 2007

(54) Processing device for end customer operation

(75) Inventors: Mukesh Karki, Issaquah, WA (US); James Robert Tryon, Layton, UT (US); Hani Umar Shakeel, Seattle, WA (US); Martin Holladay, Bremerton, WA (US); Bhrighu Sareen, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/455,491

(22) Filed: Jun. 19, 2006

(51) Int. Cl. G06F 15/16

(52) U.S. Cl. 709/203

(57) ABSTRACT

In one embodiment, a processing device may create a hardware inventory of hardware devices included in the processing device. A medium of the processing device may be prepared for installation of an operating system. The operating system may be installed onto the medium. One of a number of hardware abstraction layers may be determined to be compatible with a hardware configuration of the processing device. The determined one of the number of hardware abstraction layers may be installed onto the medium. A number of drivers for the hardware devices may be installed onto the medium, wherein the hardware drivers are based on the created hardware inventory.

### BACKGROUND

A large number of personal computers (PCs) are prepared for end customer operation each year. A large number of these PCs are previously used PCs that are recycled each year by corporations and private parties. Such previously used PCs may include one or more storage media, such as, for example, hard disks or other media having data from the previous user stored thereon.

Processing devices, such as PCs, may include a Basic Input Output System (BIOS) having processor instructions for controlling a number of devices, such as, for example, one or more disk drives, as well as a keyboard, a display screen, serial communications and miscellaneous functions. BIOS is capable of controlling storage media devices, such as hard disk drives with hard disks having a capacity of up to 8 Gigabytes. However, many previously-used PCS have hard disks or other media with a capacity larger than 8 Gigabytes. Some PCs use interfaces, which are newer than BIOS, for accessing storage media, such as, for example, hard disks. Examples of such newer interfaces include Serial Advanced Technology Attachment (SATA), SATA II, and families of Small Computer Systems Interface (SCSI) controllers, which are not recognized by BIOS and some operating systems. Access to storage media via the newer interfaces may be limited to full operating systems and may require third-party disk drivers, which may not be shipped with some operating systems.

When data on a storage medium, such as a hard disk, is erased, an index is changed to release the space used by the data such that it may later be rewritten. However, the data remains on the disk at least until the space is rewritten. In some instances, it may be possible to reconstruct “erased” data from the bits of data that remain on the medium. Further, similar to the erasing operation, formatting of a storage medium, such as a hard disk drive, may leave sensitive data on the medium, which may be recovered from the bits of data that remain on the medium. In order to guarantee that data on a storage medium, such as, for example, a hard disk, is completely destroyed, each sector of the hard disk must be overwritten with a particular value such as, for example, zeroes, or some other value, and read back to verify the overwriting of each of the sectors. The operation of overwriting data on a storage medium with a particular value is known as a “wipe”.

Some commercial wipe solutions include MS-DOS based applications which rely on BIOS INT 13h calls (disk access routines) which have an 8 gigabyte limitation (some BIOS implementations have INT 13h extensions which allow for access beyond the 8 gigabyte limit, but have limited or no access on systems with SATA and SCSI disk drives). Other solutions are based on operating systems, such as, for example, Linux or FreeBSD and include disk drivers for SATA and many popular SCSI controllers, but still lack support for specialty hardware such as advanced SCSI controllers and Redundant Array of Independent Disks (RAID) controllers.

U.S. government standard DOD5220.22-M requires that data be completely destroyed on storage media, such as, for example, hard disks. The DOD5220.22-M standard requires at least three erase passes, in which an erase character is written to the storage media, followed by a verification pass. With the above-mentioned commercial solutions, access to all storage media controllers cannot be guaranteed. Therefore, the commercial solutions that are compliant with the DOD5220.22-M standard may require the physical destruction of storage media to guarantee that the data stored thereon is completely destroyed.

An operating system may be installed on a processing device, such as, for example, a PC, by running an installation program (OS Setup), or by copying an operating system image to a bootable storage medium of a target PC.

Executing the installation program can be a manual, time consuming and error prone task. Copying the operating system image (OS Image Deployment) from a reference PC to multiple target PCs may be a better option. However, for the copying option to work accurately, a hardware configuration of the reference PC must closely match a hardware configuration of each of the target PCs. Small OEMs and system builders typically do not have resources to maintain multiple images of an operating system from numerous reference PCs. Further, PC refurbishers may not know the target PC configuration in advance.

Currently, no consistent process or guideline exists which specifies an efficient and secure method of preparing a processing device, such as, for example, a PC, for end customer usage. Further, no method or process exists for preparing disparate processing devices, such as, for example, PCs with varying hardware configurations, for end customer usage. As a result, a number of problems exist, such as:
a risk of data theft from storage media having data from a previous user stored thereon;
inadequately tested hardware;
an unverified software installation;
installation of unauthorized or pirated software;
inefficient use of resources, such as hardware, time, etc., used to prepare a processing, and
device for end customer operation.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Embodiments discussed below relate to a processing device for end customer operation. The processing device may query a number of hardware devices included in the processing device to create a hardware inventory. A medium of the processing device may be prepared for operating system installation. The operating system may be installed on the medium. The processing device may determine which one of a number of hardware abstraction layers is compatible with a hardware configuration of the processing device and may install the determined hardware abstraction layer onto the medium. A number of hardware drivers, based on the created hardware inventory, may be installed on the medium.

### DRAWINGS

In order to describe the manner in which the above-recited and other advantages and features can be obtained, a more particular description is described below and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings in which:

FIG. 1 illustrates an exemplary operating environment for embodiments consistent with the subject matter of the disclosure.

FIGS. 2A and 2B illustrate a functional block diagram of a processing device that may be used in various embodiments.

FIGS. 3A through 5 are flowcharts of exemplary methods that may be implemented in embodiments consistent with the subject matter of the disclosure.

FIGS. 6 through 8 illustrate exemplary display screens that may be displayed by a processing device consistent with the subject matter of the disclosure.

FIG. 9 illustrates an exemplary report that may be generated showing results of a medium erasing operation.

### DETAILED DESCRIPTION

Embodiments are discussed in detail below. While specific implementations are discussed, it should be understood that this is done for illustration purposes only. A person skilled in the relevant art will recognize that other components and configurations may be used without parting from the spirit and scope of the subject matter of this disclosure.

### Exemplary Operating Environment

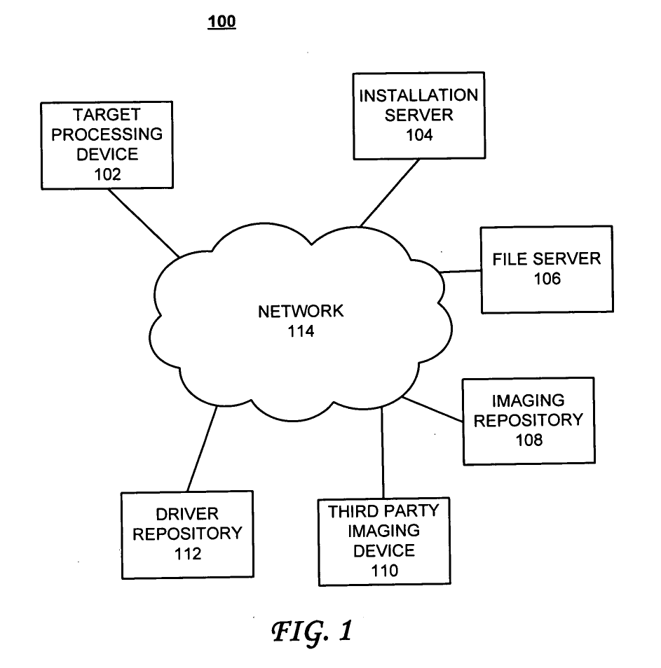

FIG. 1 illustrates an exemplary operating environment 100 for an embodiment consistent with subject matter of this disclosure. Operating environment 100 may include target processing device 102, installation server 114, file server 106, imaging repository 108, third party imaging device 110, driver repository 112 and network 114.

Target processing device 102 may be, for example, a PC or other processing device, to be prepared for end customer operation. Installation Server 104 may include a processing device having access to one or more storage media having recorded thereon at least one software tool to be executed by target processing device 102. File server 106 may include a processing device having access to one or more files or databases stored on one or more storage media. Imaging repository 108 may include a processing device with access to one or more storage media having stored thereon at least one operating system image. Third party imaging device 110 may include a processing device and may include one or more third-party tools, such as, for example, software tools for preparing an operating system image for target processing device 102. In one embodiment, third party imaging device 110 may not be required. Driver repository 112 may include a processing device having access to one or more storage media having recorded thereon drivers for multiple disparate hardware devices. In one embodiment, driver repository 112 may be a shared driver repository, which may be shared among multiple processing devices via network 114. Network 114 may be a wired or wireless network and may include a number of devices connected via wired or wireless means. Network 114 may include only one network or a number of different networks, some of which may be networks of different types. Network 114 may include, for example, a Local Area Network (LAN), a Wide Area Network (WAN), a packet switching network, an ATM network, an Ethernet network, a fiber-optic network, a Public Switched Telephone Network (PSTN), the Internet, or other types of network.

In operating environment 100, target processing device 102 may be booted from a storage medium having instructions for at least one processor of target processing device 102 to cause target processing device 102 to request one or more software tools from installation server 104 via network 114. Target processing device 102 may then execute the one or more software tools, which may cause target processing device 102 to query hardware devices included in target processing device 102 to generate a hardware inventory, store the generated hardware inventory to file server 106 via network 114, prepare a storage medium of target processing device 102 for operating system installation, record storage medium preparation information to file server 106 via network 114, request an operating system image from imaging repository 108 or third-party imaging device 110 via network 114, install the operating system image to a bootable storage media of target processing device 102, determine a hardware configuration of target processing device 102 and load and install a compatible Hardware Abstraction Layer (HAL) from driver repository 112, load and install a number of hardware drivers from driver repository 112 via network 114 based on the generated hardware inventory, and test the processing device to determine whether target processing device 102 is operational.

FIG. 1 illustrates an exemplary operating environment for an embodiment. Other operating environments or variations of the operating environment of FIG. 1 may also be used with embodiments consistent with the subject matter of this disclosure. For example, FIG. 1 illustrates installation server 104, file server 106, image repository 108, third-party imaging device 110 and driver repository 112 as being separate devices. However, one or more of the devices may be combined such that a single device or multiple devices may function as two or more of the devices.

In another embodiment, the operating environment may include a target processing device 102 without access to a network. Instead, target processing device 102 may be a standalone device with one or more storage media, such as, for example, a hard disk, a floppy disk, a CD, a DVD, a flash RAM or other storage media. One or more of the storage media may include software tools, such as those accessed by installation server 104, may be writable for writing information, such as, for example, a hardware inventory or storage medium preparation information, may include one or more operating system images for installing to a target processing device, may include a number of hardware drivers and HALs, and may include processor instructions for testing target PC 102. Target PC 102 may function similar to the embodiment described above, in operating environment 100, but instead of accessing or writing information to a device via a network, target processing device 102, instead, may access data from or write data to the one or more storage media. Further, if the above-described information is to be read from or written to multiple storage media, such that the number of storage media exceeds a number of drives, ports or other mounting means for the storage media of target processing device 102, target processing device 102 may be configured to display a message requesting that a particular storage media be made available to target processing device 102 when needed.

### Exemplary Processing Device

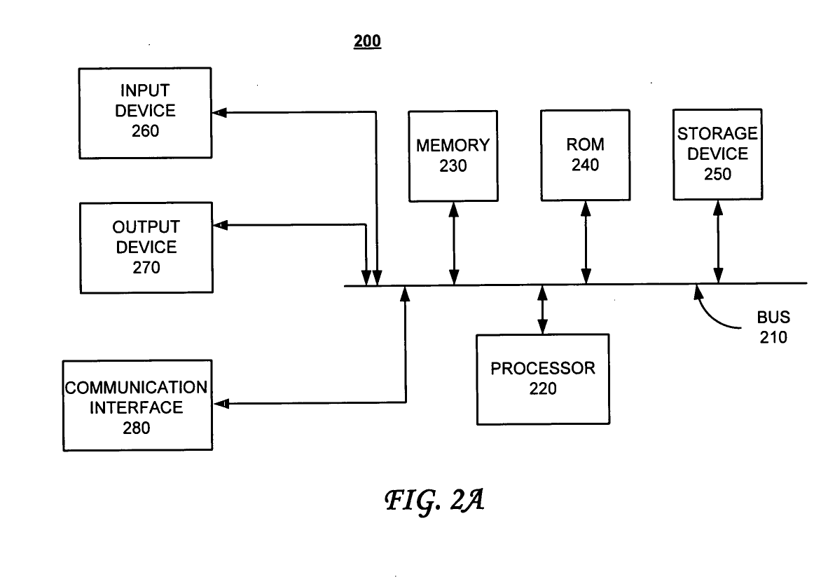

FIG. 2A is a functional block diagram which illustrates an exemplary processing device 200, which may be used to implement target processing device 102, as well as any of installation server 104, file server, 106, imaging repository 108, third-party-imaging device 110, or driver repository 112. Processing device 200 may include a bus 210, a processor 220, a memory 230, a read only memory (ROM) 240, a storage device 250, an input device 260, an output device 270, and a communication interface 280. Bus 210 may permit communication among the components of processing device 200.

Processor 220 may include at least one conventional processor or microprocessor that interprets and executes instructions. Memory 230 may be a random access memory (RAM) or another type of dynamic storage device that stores information and instructions for execution by processor 220. Memory 230 may also store temporary variables or other intermediate information used during execution of instructions by processor 220. ROM 240 may include a conventional ROM device or another type of static storage device that stores static information and instructions for processor 220. Storage device 250 may include any type of media, such as, for example, flash memory, Non-Volatile Random Access Memory (NVRAM), magnetic or optical recording media and its corresponding drive or port.

Input device 260 may include one or more conventional mechanisms that permit a user to input information to processing device 128, such as a keyboard, a mouse, a pen, a stylus, a voice recognition device, a microphone, a headset, etc. Output device 270 may include one or more conventional mechanisms that output information to the user, including a display, a printer, one or more speakers, a headset, etc. Communication interface 280 may include any transceiver-like mechanism that enables processing device 100 to communicate with other devices or networks. In one embodiment, communication interface 280 may include an interface to network 114. The interface may be a wireless, wired or optical interface. In another embodiment, the interface may include a universal serial bus (USB) interface.

Processing device 200 may perform such functions in response to processor 220 executing sequences of instructions contained in a computer-readable medium, such as, for example, memory 230, a magnetic disk, an optical disk, or other medium. Such instructions may be read into memory 230 from another computer-readable medium, such as storage device 250, or from a separate device via communication interface 280.

A motherboard is a main circuit board of a processing device, such as a PC. Processing device 200 may include a motherboard 285, as shown in FIG. 2B. Motherboard 285 may include one or more processors 220, memory 230, one or more serial ports 290, one or more parallel ports 292 and controllers 294 for controlling standard peripheral devices, such as for example, a keyboard, a disk drive and a display screen. Motherboard 285 may include other components that are not shown in FIG. 2B so as to not unnecessarily complicate FIG. 2B. For example, motherboard 285 may include mass storage interfaces and expansion slots, both of which are not shown in FIG. 2B. All of the chips that reside on a motherboard, such as motherboard 285, may be collectively called the motherboard's chipset.

### Exemplary Methods

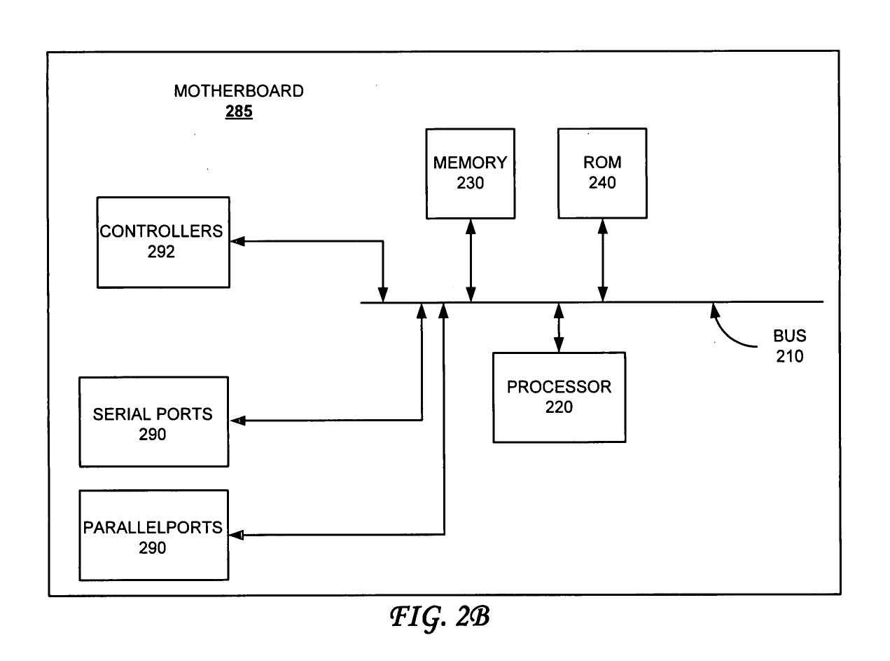

FIGS. 3A-3C are flowcharts that illustrate exemplary methods that may be practiced with embodiments consistent with the subject matter of this disclosure. The method may begin with target processing device 102 loading device preparation tools to a first medium of target processing device 102 (act 302). In one embodiment, target processing device 102 may request and receive a copy of the device preparation tools from installation server 104 via network 114. In another embodiment, target processing device 102 may copy the device preparation tools from one or more storage media, which may be connected to or may be part of target processing device 102, such as, for example, a floppy disk, a CD, a DVD, a flash RAM, or other storage medium.

Next, executing at least a first one of the device preparation tools, target processing device 102 may query hardware components of target processing device 102 and may generate a hardware inventory of the hardware components (act 304). Target processing device 102 may then record the hardware inventory (act 306). In one embodiment, target processing device 102 may record the hardware inventory to file server 106 via network 114. In another embodiment, target processing device 102 may save the hardware inventory to a storage medium, which may be connected to or may be part of target processing device 102.

Target processing device 102 may then refer to the generated hardware inventory to determine whether the hardware components of target processing device 102 are at or above a cutoff line (act 308). The cutoff line is a minimum hardware configuration, which may be configurable. The cutoff line may be configured in, for example, a file stored on a medium, which may include minimum configuration items, such as, for example, a minimum amount of memory, a minimum processor configuration, a minimum processor speed, as well as other or different configuration items. A hardware configuration below the cutoff line may be a configuration in which one or more hardware components makes the configuration obsolete and therefore, an undesirable hardware configuration. If target processing device 102 determines that the hardware configuration is below the cutoff line, then target processing device 102 may present an abort message (act 310). The abort message may be presented by displaying the message on a display screen of target processing device 302. In other embodiments, target processing device 102 may present the abort message via other means, such as, for example, printing the abort message via a printer, or alerting a user by use of a particular sound, such as, for example, a buzzer, a bell, or other sound, and storing the abort message on a medium, or other methods. In another embodiment a recommended action to update the hardware may be presented to the operator, after a hardware change (act 311), the process may be re-started.

If target processing device 102 determines that the hardware configuration is at or above the cutoff line, then target processing device 102 may execute at least a second one of the preparation tools to prepare one or more storage media of target processing device 102 (act 312). Preparing of the one or more storage media may include an erasing operation, such as a wipe, a formatting operation, and partitioning of the one or more storage media. When the preparation of the one or more storage media is completed, target processing device 102 may record storage medium preparation information to a file server 106 via network 114 or to a storage medium, which may be attached to or may be part of target processing device 102 (act 314). The storage medium preparation information may include, for example, a type of preparation performed (formatting, wiping, partitioning, etc.), whether the preparation completed successfully or not, a percentage of the process that completed, a start time, an end time, a duration of the storage medium preparation process, a speed of the preparation process, such as, for example, bytes per second, and/or other information.

Next, executing at least one of the preparation tools, target processing device 102 may request and receive an operating system image from imaging repository 108 or third-party imaging device 110 via network 114 and may install the operating system image to a bootable medium of target processing device 102 (act 316; FIG. 3B). Alternatively, target processing device 102 may copy and install the operating system image from a medium, which may be part of or may be connected to target processing device 102, such as, for example, one or more floppy disks, one or more CDs, one or more DVDs, one or more flash RAM devices, or other media. The operating system image may include only basic hardware drivers that only support certain basic operating system functions or only certain basic processor device hardware components.

Target processing device 102 may then query a chipset of motherboard 285 to determine which one of a number of Hardware Abstraction Layers (HALs) is compatible with target processing device 102 (act 318). A HAL is a component of an operating system that contains hardware-specific code for handling low-level hardware operations such as interrupt controllers, input/output (I/O) interfaces and multiprocessor communication mechanisms. The HAL abstracts, or hides, hardware-dependent details from other parts of the operating system. After determining which one of the HALs is compatible with the chipset of motherboard 285, target processing device 102 may copy and install the determined one of the HALs to the one or more bootable media of target processing device 102 (act 320). Target processing device 102 may copy the determined one of the HAL from a repository, such as, for example, driver repository 112 via network 114, or from one or more media that may be connected to target processing device 102 or may be part of target processing device 102.

Using at least one of the preparation tools, target processing device 102 may then perform testing (act 322). The testing may include a number of checks, such as, for example, determining whether the preparation of the storage medium, which occurred during act 312, completed successfully, determining whether the operating system installation, which occurred during act 316, completed successfully, determining whether the installation of the determined HAL, which occurred during act 320, completed successfully, determining whether all copied files or images were copied by target processing device 102 without errors, and/or other checks. Target processing device 102 may then determine whether the testing indicates any errors or failures (act 324). If so, then target processing device may generate and present a failure report (act 326). The failure report may be presented by displaying the failure report on a display screen of target processing device 302. In other embodiments, target processing device 102 may present the failure report via other means, such as, for example, printing the failure report via a printer, alerting a user by use of a particular sound, such as, for example, a buzzer, a bell, or other sound, and storing the failure report on a medium, or other methods. The failure report may indicate which one of the checks failed and may provide detailed information with respect to any of the checks.

If target processing device 102 determines that all tests or checks passed (act 324), then target processing device 102 may be rebooted automatically or manually, such that target processing device 102 may operate using the newly installed operating system (act 328). Operating with the newly installed operating system, target processing device 102 may then install drivers, based on the generated hardware inventory, software patches and software updates from a repository, such as, for example, driver repository 112 via network 114, or from one or more media that may be connected to or may be part of target processing device 102 (act 330).

Target processing device 102 may then perform testing with the newly installed and executing operating system and the newly installed drivers, security patches and updates (act 332). Such testing may determine whether various hardware components function properly with the operating system, drivers, patches and updates. Upon completion of the testing, target processing device 102 may present results of the testing indicating which ones of the tests passed or failed and testing details. The results may be presented on a display screen of target processing device 102, may be printed, may be stored to a particular log file, to a local medium, or to a server, such as, for example, file server 106 via network 114, or may be presented via other means.

The above method of FIGS. 3A and 3B is one exemplary method that may be implemented in embodiments consistent with the subject matter of this disclosure. The flowchart of FIG. 3C illustrates a variation of the method illustrated by FIG. 3B. In this alternative implementation, acts 302 through 320 (FIGS. 3A-3B) may be performed by target processing device 102 as described previously. However, after completing act 320, target processing device 102 may use the saved hardware inventory to determine which hardware drivers are to be installed to target processing device 102 (act 350). Target processing device 102 may then retrieve the determined hardware drivers from driver repository 112 via network 114 or from one or more media that may be connected to may be part of target processing device 102 and may then install the determined drivers to one or more bootable media of target processing device 102 (act 352).

Next, target processing device may be manually or automatically rebooted, such that after rebooting, target processing device 102 may be operating with the newly installed operating system and drivers (act 354). Target processing device 102 may then perform testing by executing a number of checks (act 356), such as, for example, determining whether the preparation of the one or more storage medium, which occurred during act 312, completed successfully, determining whether the operating system installation, which occurred during act 316, completed successfully, determining whether the installation of the determined HAL, which occurred during act 320, completed successfully, determining whether all copied files or images were copied by target processing device 102 without errors, and determining whether various hardware components function properly with the operating system and drivers. Upon completion of the testing, target processing device 102 may present results of the testing indicating which ones of the tests passed or failed and testing details (act 358). The results may be presented on a display screen of target processing device 102, may be printed, may be stored to a particular log file, or may be presented via other means.

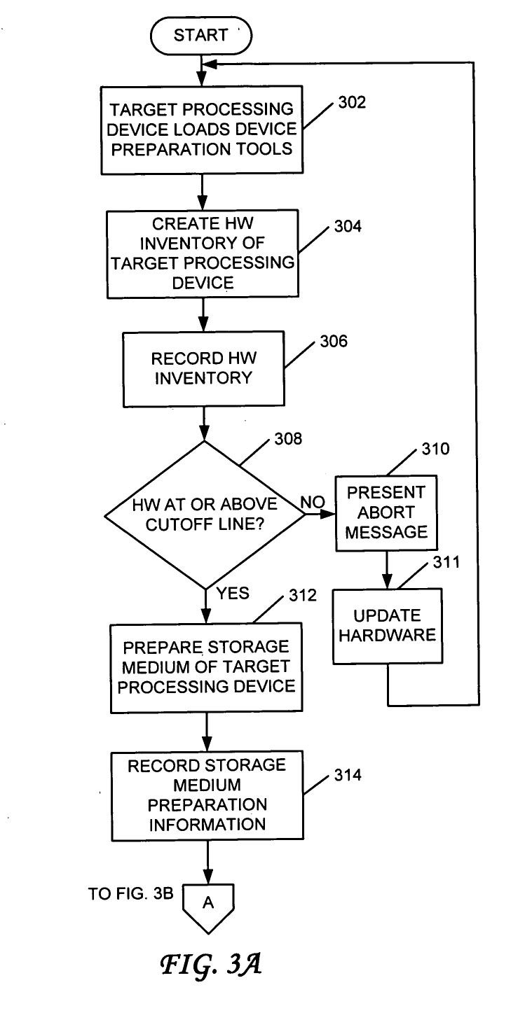

FIG. 4 is a flowchart that illustrates in more detail an exemplary method for preparing a storage medium of target processing device 102, as performed during act 312 (FIG. 3A). The method may begin by target processing device 102 performing an erase operation, such as, for example, a wipe (act 402), as described earlier. Next, target processing device 102 may partition the storage medium using any well-known method or other methods (act 404). Target processing device 102 may then format the medium (act 406). For example, a medium such as a hard disk drive or other storage medium may be formatted for a particular disk access method.

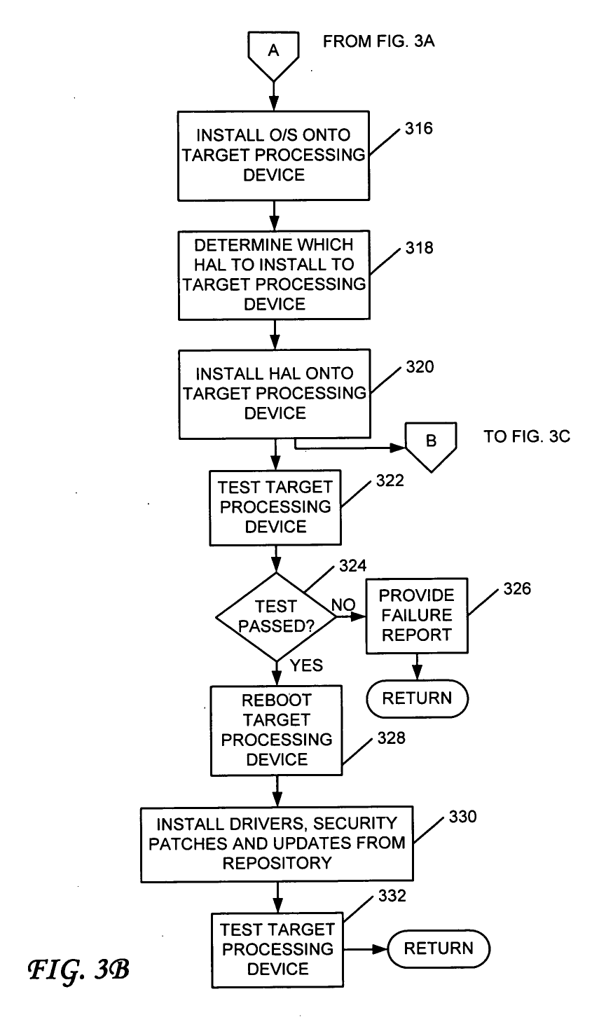

FIG. 5 is a flowchart that illustrates act 402 (FIG. 4) in more detail. First, target device 102 may request from a user and may receive a selection of one or more media devices for the wipe operation (act 502). The user may select one medium or multiple media on which the wipe operation is to be performed.

Next, target processing device 102 may request and receive a selection of wipe options for each of the selected media devices (act 504). That is, each of the selected media may be configured to have different wipe options. The wipe options may include an erase method, such as, for example, a method conforming to a standard, such as, for example, a government standard (U.S. government standard DOD5220.22-M or other government standard), an industrial standard, or other standard, or other erase methods, a number of erase passes, an erase character to be written to the one or more selected media, a selected portion or portion(s) of the one or more media on which the wipe operation is to be performed, whether a verification operation is to be performed on the wiped area of the one or more media to verify whether complete erasure has occurred, whether a status of the wiping operation is to be logged, and if so, a filename for a log file, and/or other options.

Target processing device 102 may then obtain any storage management device drivers needed for the wipe operation of the selected media devices (act 506). Target processing device 102 may obtain the storage management device drivers from driver repository 112 via network 114 or from one or media that may be connected to or may be part of target processing device 102. The storage management drivers may include drivers that provide full access to SCSI RAID controllers, as well as drivers that support SATA, SATA II and/or other SCSI controllers.

Next, target processing device may perform the wipe operation (act 508). Target processing device 102 may perform the wipe operation by using a low-level application interface, such as, for example, DeviceLoControl operations as well as kernel namespaces to access physical storage media objects, which may be supported by a storage manager. If multiple media are to be wiped, target processing device 102 may simultaneously wipe the multiple media. While performing the wipe operation on the selected one or more media, target processing device 102 may periodically report progress of the wipe operation (act 510). For example, target processing device 102 may periodically display progress of a wipe operation for one or more selected media. Target processing device 102 may display a selected wipe method, such as one conforming to the DOD5220.22-M standard or other standard, or another method, a number of erase passes to be performed on the one or more media, a current erase pass being performed, a current duration of the erase pass or of the entire erase process, a number of bytes erased, total storage medium capacity of the one or more media being wiped, a percentage of completion of the wipe process for each of the one or more media, or other progress information.

After completing the wipe process, target processing device 102 may log a report of the wipe results to a file (act 512). The file may be on a medium that may be included as part of target processing device 102 or may be connected to target processing device 102, or the file may reside on a file server, such as file server 106, which may be connected to target processing device 102 via network 114.

### Exemplary Display Screens

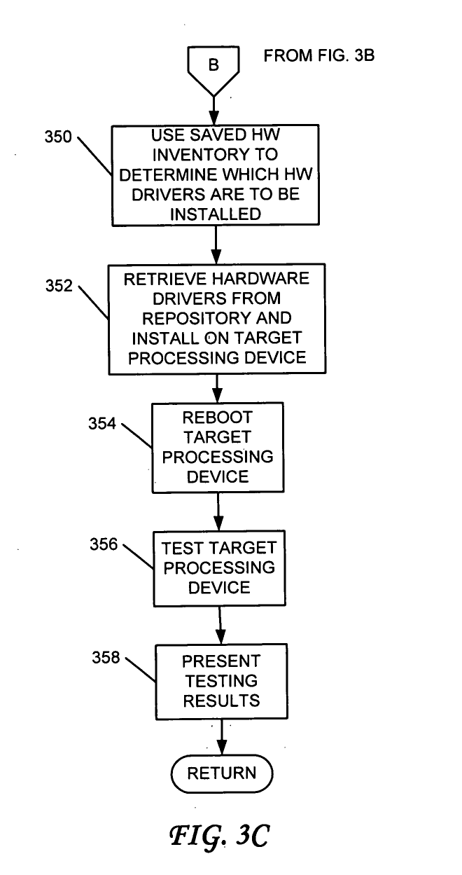

FIG. 6 illustrates an exemplary display screen 600 that may be displayed by target processing device 102 during acts 502 and 504 (FIG. 5). Display screen 600 may include an indication of one or more media 602 that may be selected by a user during act 502. The user may select one of the one or more media by using a pointing device, such as a computer mouse, cursor control buttons of a keyboard, a stylus, a user's finger touching a digitizer, which may be overlaid onto the display screen of target processing device 102, or via other means. Upon selection of one of the media, the selected one of the media may be visually confirmed by one of a number of possible means, such as a graphical indication, for example, an image of an eraser or other object appearing over an image of the selected one of the media, changing a color of an indicator representing the selected media, changing a color of an area of the display screen that surrounds the selected indicator, blinking the selected indicator, of other means.

Display screen 600 may include a box 604 or other indicator, which the user may select or check to indicate that all information on the selected medium is to be erased during the wipe operation. If the user does not indicate that all data on the selected medium is to be erased, then the display screen may have an area in which the user may indicate a filename of a file to be wiped, may indicate a folder name of a folder to be wiped, or may indicate a sector or region of the media that is to be wiped.

Display screen 600 may include a number of erasure methods 606 from which the user may select. The methods may include a method conforming to U.S. government standard DOD5220.22-M or other standard, or other methods, such as, for example, a Quick Erase method. Display screen 600 may also include a number of erase options, which the user may configure for each medium to be wiped, such as, for example, number of passes 608, an erase character 610, a verify option 612 to indicate that the wipe process should verify that the wiped areas of the medium have been completely erased, or other options.

If the user selects an erasure method conforming to the DOD5220.22-M standard, target processing device 102 may permit the user to enter a value for number of passes 608, which is 3 or more. If the user selects an erasure method, such as, for example, the Quick Erase method, target processing device 102 may permit the user to enter a value for number of passes 608, which is 1 or more.

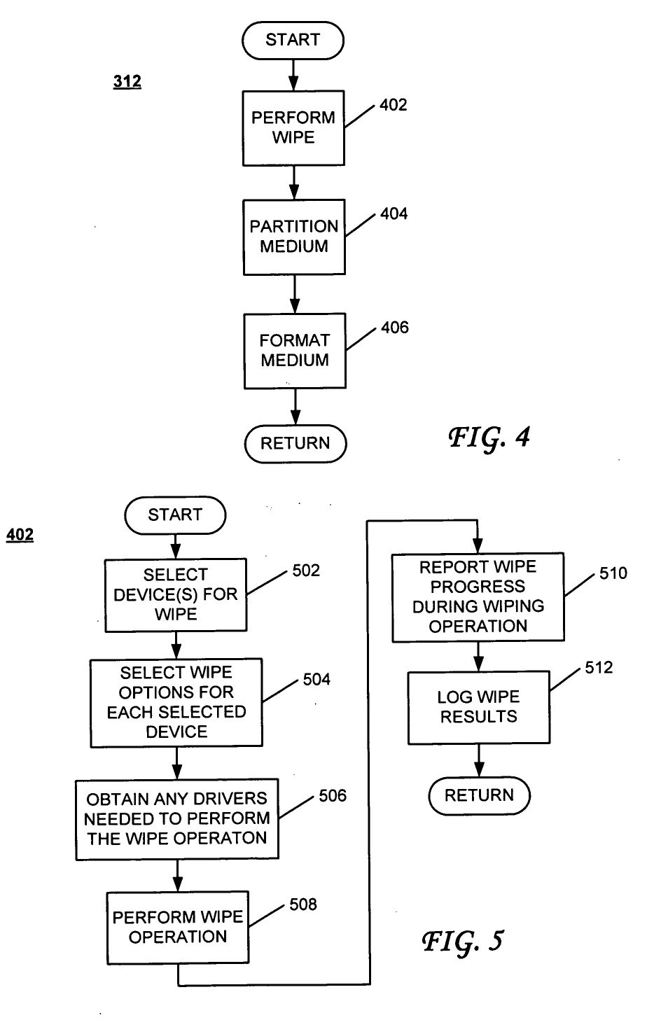

FIG. 7 illustrates an exemplary display screen 700 that target processing device 102 may display to provide a user an option to indicate whether a status of the wipe operation is to be logged during the wipe operation. The display may include indication of one or more media 702, from which the user may select a particular medium. The user may select the particular one of the one or more media in the manner described previously with respect to FIG. 6. Upon selection of one of the media, the selected one of the media may be visually confirmed by one of a number of possible means, including a graphical indication, such as an eraser or other object, changing a color of an indicator representing the selected media, changing a color of an area of the display screen that surrounds the selected indicator, blinking the selected indicator, or other means.

Display screen 700 may include a box 704 or other indicator, which the user may select or check to indicate that a status of the wipe operation for a selected one of the one or more media is to be logged to a medium, such as, for example, a file on a disk or other medium. If the user indicates that the status of the wipe operation is to be logged, then the user may enter a filename in a filename indicator portion 706 of display screen 700. Display screen 700 may also include a box 708 or other indicator, which the user may select or check to indicate that log data is to be appended to an indicated file.

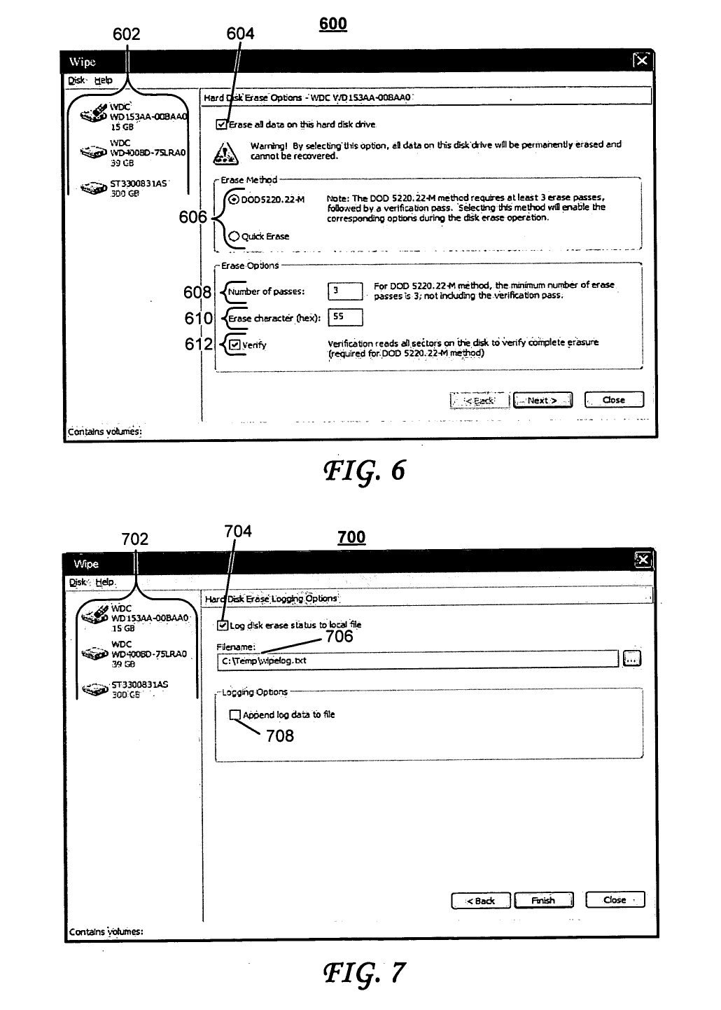

FIG. 8 illustrates exemplary screen display screen 800, which includes an indicator of one or more media 802, method selected 804, number of passes 806, current pass 806, duration 810, bytes erased 812, medium capacity 814 and a completion indicator 816. Indicator of one or more media 802 may provide an indication with respect to which one of a number of media the display pertains. As shown in display 800 an arrow pointing to a particular one of the media may indicate the media to which the display pertains. The user may select one of the one or more media by using any of the methods discussed previously with respect to FIG. 6 or 7. Other methods may also be used to indicate the particular one of the media. Further, display 800 may include a graphical means of indicating to which one(s) of the one or more media display 800 does not pertain. For example, a circle with a slash through the circle may be shown over one(s) of indicator of one or more media 802 to indicate that display 800 does not pertain to those particular one(s) of the media. Method selected 804 may indicate a wiping method used, such as one conforming to the DOD5220.22-M standard or other standard, or another method. Number of passes 806 may indicate a number of passes configured for the wipe operation to be performed on the one of the media. Current pass 808 may indicate a current pass being performed during the wipe operation of a particular one of the one or more media. Duration 810 may indicate a current duration of the wipe operation of the particular one of the one or more media. Bytes erased 812 may indicate a number of bytes to which an erase character has been written during the wipe process of the particular one of the one or more media. Total disk capacity 814 may indicate a total capacity of a disk, or other media being wiped. Percent complete 816 may be a graphical illustration showing graphically and numerically a percentage of the wipe operation that is complete for the particular one of the one or more media.

### Exemplary Report

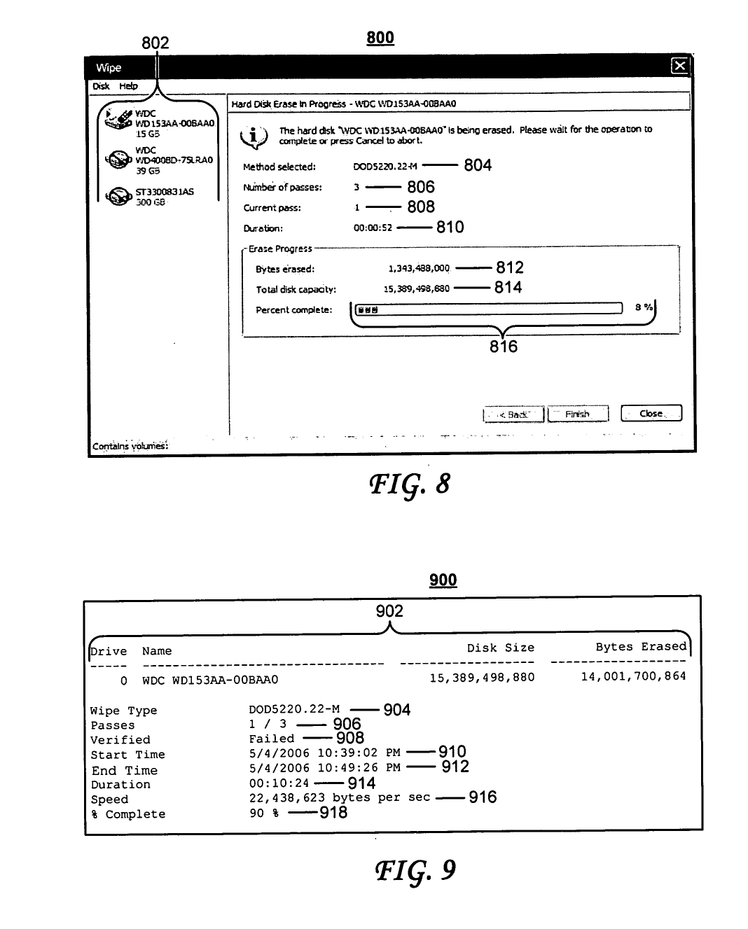

FIG. 9 illustrates an exemplary report that may be produced as a result of performing the wipe process. The report may include medium information 902, wipe type 904, passes 906, verification 908, start time 910, end time 912, duration 914, speed 916, percent complete 918, and/or other information.

Medium information 902 may include information describing a particular medium, as well as a capacity of the medium, and an amount of data erased in bytes or another unit. Wipe type 904 may indicate a method used to perform the wiping operation. Passes 906 may indicate a current pass and a number of passes configured to be performed, such as, for example, pass 1 of 3 passes (1/3). Verification 908 may indicate whether a verification portion of the wipe process passed or failed. Start time 910 may indicate a start time for the wipe process of the medium described by medium information 902. End time 904 may indicate an end time for the wipe process of the medium described by medium information 902. Duration 914 may indicate an amount of time the wiping process executed for the medium described by medium information 902. Speed 916 may indicate a speed, such as, for example, a/ speed for writing an erase character to the medium described by media information 902. The speed may be indicated by a number of bytes per second or any other useful measure. Percent complete 918 may indicate an amount of the wipe process that completed for the medium described by media information 902. Display 900 shows a 90% value for percent complete 918, which may indicate a failed or aborted wipe process.

### CONCLUSION

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Although the above description may contain specific details, they should not be construed as limiting the claims in any way. Other configurations of the described embodiments are part of the scope of this disclosure. Further, implementations consistent with the subject matter of this disclosure may have more or fewer acts than as described, or may implement acts in a different order than as shown. Accordingly, the appended claims and their legal equivalents should only define the invention, rather than any specific examples given.

We claim as our invention:

1. A method for preparing a processing device for end customer usage, the method comprising:
creating a hardware inventory of a plurality of hardware devices by querying the plurality of hardware devices comprised by the processing device;
preparing a medium of the processing device for installation of an operating system;
installing the operating system onto the medium of the processing device;
determining which one of a plurality of hardware abstraction layers is compatible with a hardware configuration of the processing device;
installing the determined one of the plurality of hardware abstraction layers onto the medium of the processing device; and
installing a plurality of hardware drivers for the plurality of hardware devices onto the medium, the plurality of hardware drivers being based on the created hardware inventory.

2. The method of claim 1, further comprising testing the processing device to determine whether the processing device is prepared for end customer usage.

3. The method of claim 1, further comprising:
installing at least one of software patches or software updates.

4. The method of claim 1, wherein the preparing a second medium of the processing device for installation of an operating system further comprises:
erasing information stored on the medium by performing at least three passes of writing an erase character to at least one portion of the medium; and
verifying that the at least one portion of the medium is erased.

5. The method of claim 1, wherein the preparing a second medium of the processing device for installation of an operating system further comprises:
erasing information stored on the medium by performing at least three passes of writing an erase character to at least one portion of the medium; and
verifying that the at least one portion of the medium is erased, wherein
at least one of the erase character or a number passes of writing the erase character is configurable.

6. The method of claim 1, wherein the preparing a second medium of the processing device for installation of an operating system further comprises:
erasing information stored on the medium by performing at least three passes of writing an erase character to at least one portion of the medium; and
verifying that the at least one portion of the medium is erased, wherein
an operation of the erasing of the information on the medium conforms to a standard.

7. The method of claim 1, wherein the preparing a second medium of the processing device for installation of an operating system further comprises:
erasing information stored on the medium by performing at least three passes of writing an erase character to at least one portion of the medium;
simultaneously erasing information stored on at least one other medium of the processing device by performing at least three passes of writing the erase character to at least one portion of the at least one other medium; and
verifying that the at least one portion of the medium is erased,

8. The method of claim 1, wherein the installing of the operating system onto the medium of the processing device, further comprises:
installing the operating system with only a basic set of hardware drivers.

9. At least one machine-readable medium including instructions for at least one processor of a processing device, the at least one machine-readable medium comprising:
instructions for querying each of a plurality of hardware devices comprised by the processing device to create a hardware inventory of the plurality of hardware devices;
instructions for performing an erasing operation on a first medium of the processing device before installing an operating system to the first medium, the erasing operation including at least three passes of writing a configurable erase character to the first medium to completely erase information stored on the first medium;
instructions for installing the operating system onto the first medium of the processing device, the operating system including only a basic set of hardware drivers;
instructions for determining which one of a plurality of hardware abstraction layers is compatible with a hardware configuration of the processing device;
instructions for installing the determined one of the plurality of hardware abstraction layers onto the first medium of the processing device; and
instructions for installing a plurality of hardware drivers for the plurality of hardware devices onto the first medium, the plurality of hardware drivers being based on the created hardware inventory.

10. The at least one machine-readable medium of claim 9, further comprising:
instructions for formatting the first medium.

11. The at least one machine-readable medium of claim 9, further comprising:
instructions for reporting a status of the erasing operation.

12. The at least one machine-readable medium of claim 9, further comprising:
instructions for installing software patches and software updates to the first medium after installing the operating system.

13. The at least one machine-readable medium of claim 9, further comprising:
instructions for permitting a user to select a plurality of media of the processing device upon which to perform the erasing operation; and
instructions for permitting the user to select unique erase options for each of the selected ones of the plurality of media.

14. The at least one machine-readable medium of claim 9, further comprising instructions for simultaneously performing the erasing operation to a plurality of media of the processing device.

15. A processing device comprising:
at least one processor;
a storage device having a storage medium; and
a bus connecting the at least one processor with the storage device, wherein:
the processing device is configured to perform:
querying of each of a plurality of hardware devices comprised by the processing device to generate a hardware inventory of the plurality of hardware devices,
erasing, formatting and partitioning the storage medium, the erasing including at least three passes of writing a configurable erase character to the storage medium to erase information stored on the storage medium,
installing an operating system and only a basic set of hardware drivers to the storage medium,
extracting information with respect to a chipset of a motherboard to determine which one of a plurality of hardware abstraction layers to install onto the storage medium,
installing the determined one of the plurality of hardware abstraction layers onto the storage medium,
installing a plurality of hardware drivers to the storage medium, the plurality of hardware drivers being based on the generated hardware inventory, and
testing the processing device to determine whether the processing device is operational with the installed operating system, the installed hardware drivers and the installed hardware abstraction layer.

16. The processing device of claim 15, wherein the processing device is further configured to perform:
saving the hardware inventory on a file server connected to the processing device via a network.

17. The processing device of claim 15, wherein the processing device is further configured to perform:
saving the hardware inventory on a file server connected to the processing device via a network; and
logging information about the erasing of the storage medium to the file server.

18. The processing device of claim 15, wherein the processing device is further configured to perform:
accessing an image of the operating system and the basic set of hardware drivers from a repository.

19. The processing device of claim 15, wherein the processing device is further configured to perform:
accessing the plurality of hardware drivers based on the generated hardware inventory from a shared driver repository.

20. The processing device of claim 15, wherein the processing device is configured to perform:
erasing a plurality of storage media of the processing device simultaneously, options for the erasing being separately configurable for each of the plurality of storage media.
